(19) United States
(12) Patent Application Publication
(10) Pub. No.: US 2017/0092165 A1
(43) Pub. Date: Mar. 30, 2017

(54) ILLUMINATED MOBILE SIGN SYSTEM AND METHOD

(71) Applicant: FABIANA CAVELARIS, WEST HILLS, CA (US)

(72) Inventor: FABIANA CAVELARIS, WEST HILLS, CA (US)

(21) Appl. No.: 15/267,391

(22) Filed: Sep. 16, 2016

Related U.S. Application Data
(60) Provisional application No. 62/284,349, filed on Sep. 28, 2015.

(51) Int. Cl. G09F 21/04; F21S 9/03; F21V 23/04; F21V 8/00; F21V 21/092; F21V 23/06; G09F 13/00; F21S 4/15

(52) U.S. Cl. CPC G09F 21/04; G09F 13/00; F21S 9/035; F21S 4/15; G02B 6/001; F21V 21/092; F21V 23/06; F21V 23/04

(57) ABSTRACT

An illuminated mobile sign system including a sign assembly, a charging assembly, and at least one suction-cup. The sign assembly includes a luminous-fiber-optic-fabric, and a rigid-backboard in structural and functional combination. The rigid-backboard of the sign assembly includes a front-side, a back-side, and a periphery. The charging assembly includes, and is defined by, a thin-cell-rechargeable-battery, one or more photovoltaic-cells, a male-power-connector, a female-power-connector, and a battery-connector. The rigid-backboard includes a front-side, a back-side, and a periphery. The periphery exhibits a badge-shape to provide a more formal aesthetic design. Illuminated mobile sign system is weather-resistant. The illuminated mobile sign system is structured and arranged to allow a user to display an illuminated image or illuminated-message upon a surface via the sign assembly. The illuminated image includes alphanumeric text, as well as graphics.

### CROSS-REFERENCE TO RELATED APPLICATION

The present application is related to and claims priority from prior provisional application Ser. No. 62/284,349, filed Sep. 28, 2015, which application is incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of signage and more specifically relates to a mobile sign system.

### DESCRIPTION OF RELATED ART

Generally speaking, a sign is an object to display a message, image, or combination thereof. A sign can be mounted upon a sign post, independently standing, affixed to a surface, or displayed by other suitable means. Signs may include messages and/images related to political messages, safety, sports related enthusiastics, trademarks, or simply to provide aesthetic improvement.

Signs may be static, such that the images, graphics, or text are stationary and directly printed upon a rigid surface, or a sign may be based upon illuminated technology. Such illuminated technology can include the use of light-emitting-diodes, fiber optics, or a series of incandescent light bulbs in order to construct the image, graphic(s), or text. Such illuminated signs often require an electrical power source. Static signs may include reflective surfaces or material such that they are more easily viewable during low light conditions.

One such limitation with the common sign is that most are not visible without ambient or reflective light. As in the case with illuminated signs, these signs require a constant and reliable power source to remain illuminated to operate to be visible. Some illuminated signs may be connected to a municipal power source (i.e., hard-wired), or include a remote battery power supply. However, illuminated signs that are mobile, such as mounted upon a vehicle, cannot be wired and most batteries have a short power supply which requires recharging. As such, a suitable solution is desired.

Several attempts have been made to solve the above-mentioned problems such as those found in the following references: U.S. Pat. No. 2,783,540 to Jacobs, U.S. Pat. No. 6,860,047 to Rodriguez, US 2009/0084009 to Vandergriff et al., US 2011/0107733 to Wells, US 2014/0363038 to Coleman et al., and US 2015/0047237 to Meza. This art is representative of signage. However, none of the above inventions and patents, taken either singly or in combination, is seen to describe the invention as claimed.

### BRIEF SUMMARY OF THE INVENTION

In view of the foregoing disadvantages inherent in the known signage art, the present invention provides a novel illuminated mobile sign system. The general purpose of the present invention, which will be described subsequently in greater detail, is to provide a powered-electronic signage device which displays illuminated messages and/or graphics with the device removably affixable to a surface. The device is powered by a thin-cell battery which is rechargeable by ambient light via a photovoltaic cell.

An illuminated mobile sign system is disclosed herein, in embodiments; embodiments include a sign assembly, a charging assembly, and at least one suction-cup; the at least one suction-cup being removable and reversible to provide a user with multiple mounting options for the illuminated mobile sign system. The sign assembly includes a luminous-fiber-optic-fabric, and a rigid-backboard, in structural and functional combination. The illuminated mobile sign system includes the sign assembly, the charging assembly, and the at least one suction-cup in functional combination.

The rigid-backboard of the sign assembly includes a front-side, a back-side, and a periphery. The charging assembly includes, and is defined by, a thin-cell-rechargeable-battery, one or more photovoltaic-cells, a male-power-connector, a female-power-connector, and a battery-connector in functional combination. In embodiments, the rigid-backboard comprises and is defined by the front-side, the back-side, and the periphery. Embodiments include the periphery which exhibits a badge-shape to provide a more formal aesthetic design. Embodiments of the illuminated mobile sign system include weather-resistance. The illuminated mobile sign system is structured and arranged to allow a user to display an illuminated image upon and/or through a surface (e.g., a transparent surface, such as a glass, plastic, etc.) via the sign assembly. Embodiments include the illuminated image which includes alphanumeric text, as well as graphics and/or a combination thereof.

The thin-cell-rechargeable-battery of the charging assembly is affixable to the front-side of the rigid-backboard, in an embodiment. Also, the one or more photovoltaic-cells are each affixable to the front-side of the rigid-backboard nearest the periphery of the rigid-backboard. The one or more photovoltaic-cells are structured and arranged to charge the thin-cell-rechargeable-battery via a light-source. Embodiments include the light-source being from ultra-violet radiation from a solar-source, or man-made light sources, as well as any other suitable light-source.

Embodiments of charging assembly are structured and arranged to provide an electrical power source to the luminous-fiber-optic-fabric, with the luminous-fiber-optic-fabric structured and arranged to cover and conceal the thin-cell-rechargeable-battery. The luminous-fiber-optic-fabric includes an on-off switch, in embodiments. Some embodiments include thin-cell-rechargeable-battery which is removable and replaceable. Embodiments of charging assembly can include a charging-port such that the user is able to recharge the thin-cell-rechargeable-battery via an electrical-current-source (e.g., household electrical, automobile electrical system, etc.).

The battery-connector provides electrical coupling between the one or more photovoltaic-cells and the thin-cell-rechargeable-battery. Together, the male-power-connector and the female-power-connector provide detachable electrical coupling between the luminous-fiber-optic-fabric and the thin-cell-rechargeable-battery.

Embodiments include the rigid-backboard constructed from a plastic material to provide durability and longevity, and to prevent damage to the surface during use. The at least one suction-cup is detachably affixable to the rigid-backboard to provide a detachable coupling to the surface. In embodiments, the surface is a window of a vehicle (e.g., car, truck, van, bus, tractor-trailer, etc.).

According to an embodiment, a kit is disclosed; the kit including a sign assembly, a charging-assembly, at least one suction-cup, and a set of user instructions.

According to another embodiment, a method for using illuminated mobile sign system is also disclosed herein. The method for using an illuminated mobile sign system includes the steps of: providing an illuminated mobile sign system (comprising the sign assembly, the charging assembly, and at least one suction-cup), affixing the illuminated mobile sign system to a surface, charging the illuminated mobile sign system via a light-source, switching the illuminated mobile sign system into an on-mode, displaying an illuminated-message, switching the illuminated mobile sign system into an off-mode, and removing the illuminated mobile sign system from the surface.

The present invention holds significant improvements and serves as an illuminated mobile sign system. Preferably, a sign should provide a removable device that is electrically powered to display illuminated graphics and/or messages with the capability to be rechargeable by a light source and, yet would operate reliably and be manufactured at a modest expense. Thus, a need exists for a reliable illuminated mobile sign system to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, illuminated mobile sign systems, constructed and operative according to the teachings of the present disclosure.

FIG. 1 shows a perspective view illustrating an illuminated mobile sign system during an ‘in-use’ condition attached to a surface according to an embodiment of the disclosure.

FIG. 2 is a front-perspective view illustrating the illuminated mobile sign system including a sign assembly according to an embodiment of the present invention of the disclosure.

FIG. 3 is a front-perspective view illustrating the charging assembly of the illuminated mobile sign system, with the sign assembly removed/not shown, according to an embodiment of the present disclosure.

FIG. 4 is a front-perspective view illustrating the rigid-backboard of the sign assembly, with the luminous-fiber-optic-fabric removed/not shown, according to an embodiment of the present disclosure.

FIG. 5 is a flow diagram illustrating a method of use for the illuminated mobile sign system according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a sign and more particularly to an illuminated mobile sign system as used to improve the mobile display of messages and graphics upon a surface where the display is rechargeable by an external light source.

Generally speaking, an illuminated mobile sign system, which may be referred to as “Vehicle Window Hawk Sign” (“Hawk Sign”), is a unique sign that may be secured to a vehicle window, thereby warning and alerting other drivers to not text while driving. The Hawk Sign insignia may include bright colors and may be placed on a luminous fiber optic fabric such that the sign may light up to become more visible during low light conditions, such as nighttime. The system may include a rechargeable battery contained within the sign which operates in conjunction with a photovoltaic-cell which absorbs ambient light and may charge the battery for easy use and long life.

The device is simple and inexpensive and may become a popular sign that consumers can use; and is intended to save lives to prevent people from texting while driving a vehicle. Texting while driving has become more dangerous than talking on the phone while driving. Many authorities have instituted educational methods of displaying such messages. The Hawk Sign device may be the new method of reminding drivers of the dangers of texting while driving.

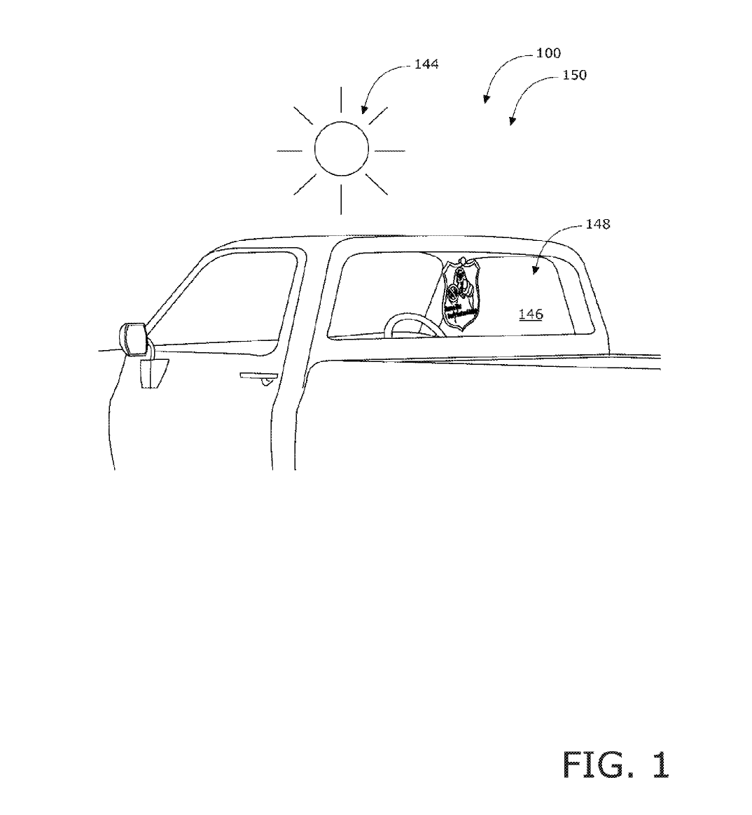

Referring now more specifically to the drawings by numerals of reference there is shown in FIG. 1, illuminated mobile sign system 100 during an ‘in-use’ condition 150, with illuminated mobile sign system 100 detachably coupled to surface 146. Embodiments of illuminated mobile sign system 100 may include surface 146 which may include window 148 of a vehicle. Also shown in FIG. 1, illuminated mobile sign system 100 may be structured and arranged to be charged by light-source 144. Light-source 144 may be ultra-violet radiation from a solar-source (i.e., solar radiation), or light-source 144 may be created by a man-made-source (e.g., light bulb, fire, etc.), in some embodiments.

At least one suction-cup 138 may be removable and reversible to provide the user with multiple mounting options (e.g., reversing illuminated mobile sign system 100, rotating illuminated mobile sign system 100, providing additional support to illuminated mobile sign system 100 upon surface 146, etc.)

Embodiments of illuminated mobile sign system 100 may include an illuminated image or illuminated-message 142 which includes alphanumeric text, pictures, graphics, logos, and/or trademarks.

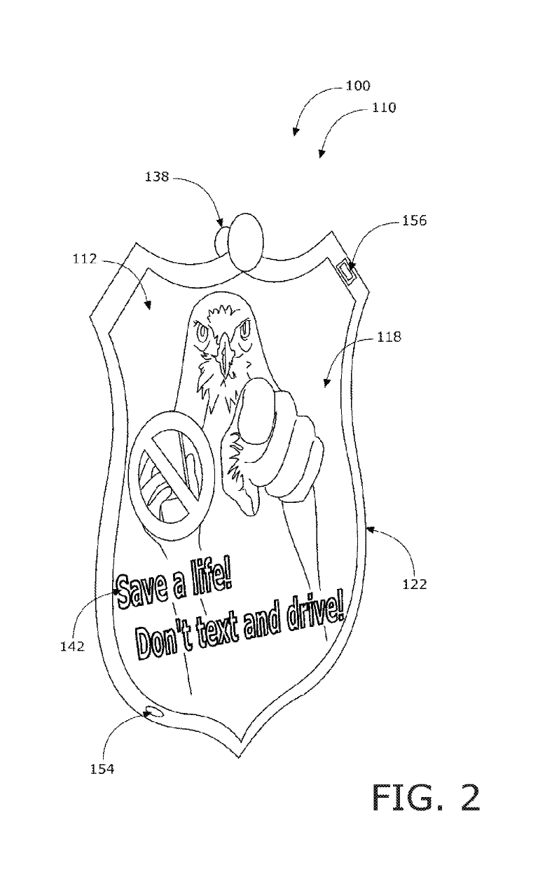

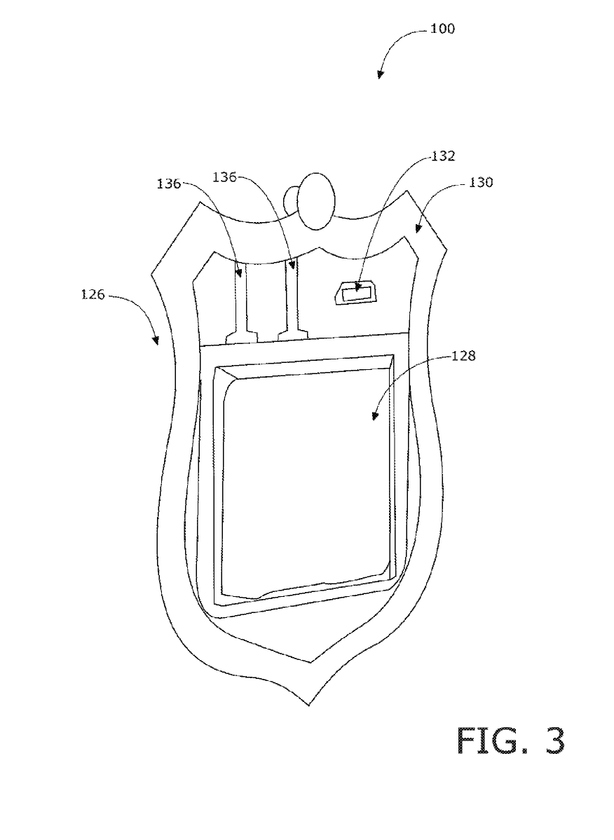

Referring now to FIGS. 2 and 3, illuminated mobile sign system 100 includes sign assembly 110, charging assembly 126, and at least one suction-cup 138 in functional combination. Sign assembly 110 may comprise luminous-fiber-optic-fabric 112, and rigid-backboard 116, in structural and functional combination. Rigid-backboard 116 may comprise and be defined by front-side 118, back-side 120, and periphery 122. At least one suction-cup 138 may be detachably affixable to rigid-backboard 116 to provide a detachable coupling to surface 146. Charging assembly 126 may be structured and arranged to provide an electrical power source to luminous-fiber-optic-fabric 112. Illuminated mobile sign system 100 may be structured and arranged to allow the user to display illuminated image/illuminated-message 142 upon surface 146 via sign assembly 110. Luminous-fiber-optic-fabric 112 may be dimmable in some embodiments such that the user may alter a brightness of luminous-fiber-optic-fiber 112. Embodiments may also include luminous-fiber-optic-fabric 112 that also may include on-off switch 156.

Referring now to FIG. 2, charging assembly 126 may comprise thin-cell-rechargeable-battery 128, one or more photovoltaic-cell(s) 130, male-power-connector 132, female-power-connector 134, and battery-connector 136 in functional combination, where thin-cell-rechargeable-battery 128 may be affixable to front-side 118 of rigid-backboard 116. Male-power-connector 132 and female-power-connector 134 may provide detachable electrical coupling between luminous-fiber-optic-fabric 112 and thin-cell-rechargeable-battery 128. Charging assembly 126 may further include charging-port 154 such that the user may recharge thin-cell-rechargeable-battery 128 via an electrical-current-source (e.g., 120 volt AC, 240 volt AC, 12 volt DC, etc.).

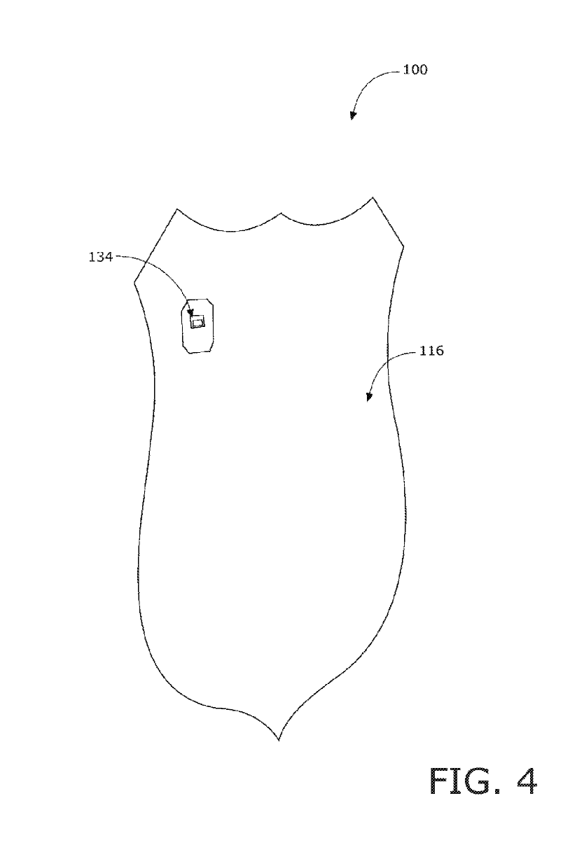

As can be seen in FIGS. 3 and 4, luminous-fiber-optic-fabric 112 may be structured and arranged to cover and conceal thin-cell-rechargeable-battery 128. One or more photovoltaic-cell(s) 130 may be structured and arranged to charge thin-cell-rechargeable-battery 128 via a light-source 144. One or more photovoltaic-cells 130 may each be affixable to front-side 118 of rigid-backboard 116 nearest periphery 122 of rigid-backboard 116 and battery-connector 136 may provide electrical coupling between one or more photovoltaic-cell(s) 130 and thin-cell-rechargeable-battery 128. Thin-cell-rechargeable-battery 128 may be removable and replaceable in some embodiments

Referring to FIG. 4, periphery 122 of rigid-backboard 116 may exhibit a badge-shape to provide a more formal aesthetic design. Also, rigid-backboard 116 may be constructed from a plastic material to provide durability and longevity and prevent damage to surface 146 during use, in some embodiments. Embodiments may also include rigid-backboard 116 constructed from an aluminum alloy to be lightweight, or rigid-backboard 116 may be constructed from a ferrous-metallic alloy to provide increased strength, rigidity, and durability during use, depending upon user preferences and specific applications.

Illuminated mobile sign system 100 may be weather-resistant in some embodiments and multiple illuminated mobile sign systems 100 may be coupleable such that power may be shareable by and between each of multiple illuminated mobile sign systems 100.

Illuminated mobile sign system 100 may be sold as a kit comprising the following parts: at least one sign assembly 110; at least one charging-assembly 126; at least one suction-cup 138; and at least one set of user instructions. The kit has instructions such that functional relationships are detailed in relation to the structure of the invention (such that the invention can be used, maintained, or the like in a preferred manner).

Illuminated mobile sign system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different display combinations, parts may be sold separately, etc., may be sufficient.

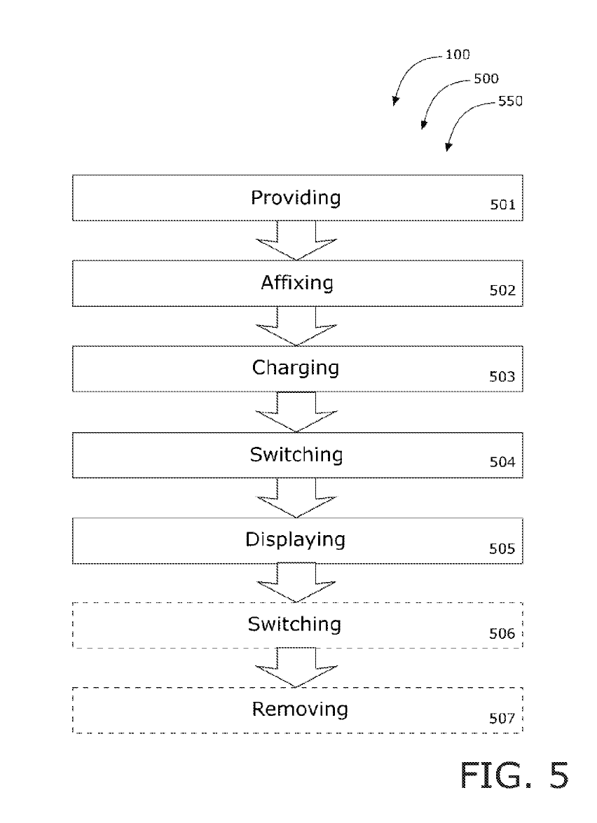

Referring now to FIG. 5 showing a flow diagram 550 illustrating method of use 500 for illuminated mobile sign system 100 according to an embodiment of the present invention of FIGS. 1-4. As shown, method of use 500 may comprise the steps of: step one 501, providing illuminated mobile sign system 100 comprising sign assembly 110, charging assembly 126, and at least one suction-cup 138; step two 502, affixing illuminated mobile sign system 100 to surface 146; step three 503, charging illuminated mobile sign system 100 via light-source 144; step four 504, switching illuminated mobile sign system 100 into an on-mode; step five 505, displaying illuminated-message 142; step six 506, switching illuminated mobile sign system 100 into an off-mode; and step seven 507, and removing illuminated mobile sign system 100 from surface 146.

It should be noted that step six 506 and step seven 507 are optional steps and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An illuminated mobile sign system comprising:
a sign assembly comprising;
a luminous-fiber-optic-fabric; and
a rigid-backboard including;
a front-side;
a back-side; and
a periphery;
a charging assembly comprising;
a thin-cell-rechargeable-battery;
one or more photovoltaic-cells;
a male-power-connector;
a female-power-connector;
a battery-connector; and
at least one suction-cup;
wherein said illuminated mobile sign system comprises said sign assembly, said charging assembly, and said at least one suction-cup in functional combination,
wherein said sign assembly comprises said luminous-fiber-optic-fabric, and said rigid-backboard in structural and functional combination;
wherein said rigid-backboard comprises and is defined by said front-side, said back-side, and said periphery;
wherein said charging assembly comprises said thin-cell-rechargeable-battery, said one or more photovoltaic-cells, said male-power-connector, and said female-power-connector, and said battery-connector in functional combination;
wherein said thin-cell-rechargeable-battery is affixable to said front-side of said rigid-backboard;
wherein said one or more photovoltaic-cells are each affixable to said front-side of said rigid-backboard nearest said periphery of said rigid-backboard;
wherein said battery-connector provides electrical coupling between said one or more photovoltaic-cells and said thin-cell-rechargeable-battery;
wherein said male-power-connector and said female-power-connector provide detachable electrical coupling between said luminous-fiber-optic-fabric and said thin-cell-rechargeable-battery;
wherein said at least one suction-cup is detachably affixable to said rigid-backboard to provide a detachable coupling to a surface;
wherein said one or more photovoltaic-cells are structured and arranged to charge said thin-cell-rechargeable-battery via a light-source;
wherein said charging assembly is structured and arranged to provide an electrical power source to said luminous-fiber-optic-fabric;
wherein said luminous-fiber-optic-fabric is structured and arranged to cover and conceal said thin-cell-rechargeable-battery; and
wherein said illuminated mobile sign system is structured and arranged to allow a user to display an illuminated image upon said surface via said sign assembly.

2. The illuminated mobile sign system of claim 1 wherein said illuminated image includes alphanumeric text.

3. The illuminated mobile sign system of claim 1 wherein said light-source is ultra-violet radiation from a solar-source.

4. The illuminated mobile sign system of claim 1 wherein said light-source is created by a man-made-source.

5. The illuminated mobile sign system of claim 1 wherein said thin-cell-rechargeable-battery is removable and replaceable.

6. The illuminated mobile sign system of claim 1 wherein said charging assembly further includes a charging-port such that said user can recharge said thin-cell-rechargeable-battery via an electrical-current-source.

7. The illuminated mobile sign system of claim 1 wherein said at least one suction-cup is removable and reversible to provide said user with multiple mounting options.

8. The illuminated mobile sign system of claim 1 wherein said rigid-backboard is constructed from a plastic material to provide durability and longevity and prevent damage to said surface during use.

9. The illuminated mobile sign system of claim 1 wherein said rigid-backboard is constructed from an aluminum alloy to be lightweight.

10. The illuminated mobile sign system of claim 1 wherein said rigid-backboard is constructed from a ferrous-metallic alloy to provide increased strength, rigidity, and durability during use.

11. The illuminated mobile sign system of claim 1 wherein said luminous-fiber-optic-fabric further includes an on-off switch.

12. The illuminated mobile sign system of claim 1 wherein one or more of said illuminated mobile sign systems are coupleable such that power is shareable by and between each of said multiple illuminated mobile sign systems.

13. The illuminated mobile sign system of claim 1 wherein said illuminated mobile sign system is weather-resistant.

14. The illuminated mobile sign system of claim 1 wherein said luminous-fiber-optic-fabric is dimmable such that said user may alter a brightness of said luminous-fiber-optic-fabric.

15. The illuminated mobile sign system of claim 1 wherein said periphery exhibits a badge-shape to provide a more formal aesthetic design.

16. The illuminated mobile sign system of claim 1 wherein said surface is a window of a vehicle.

17. An illuminated mobile sign system comprising:
a sign assembly comprising;
a luminous-fiber-optic-fabric; and
a rigid-backboard including;
a front-side;
a back-side; and
a periphery;
a charging assembly comprising;
a thin-cell-rechargeable-battery;
one or more photovoltaic-cells;
a male-power-connector;
a female-power-connector;
a battery-connector; and
at least one suction-cup;
wherein said illuminated mobile sign system comprises said sign assembly, said charging assembly, and said at least one suction-cup in functional combination,
wherein said sign assembly comprises said luminous-fiber-optic-fabric, and said rigid-backboard in structural and functional combination;
wherein said rigid-backboard comprises and is defined by said front-side, said back-side, and said periphery;
wherein said charging assembly comprises said thin-cell-rechargeable-battery, said one or more photovoltaic-cells, said male-power-connector, and said female-power-connector, and said battery-connector in functional combination;
wherein said thin-cell-rechargeable-battery is affixable to said front-side of said rigid-backboard;
wherein said one or more photovoltaic-cells are each affixable to said front-side of said rigid-backboard nearest said periphery of said rigid-backboard;
wherein said battery-connector provides electrical coupling between said one or more photovoltaic-cells and said thin-cell-rechargeable-battery;
wherein said male-power-connector and said female-power-connector provide detachable electrical coupling between said luminous-fiber-optic-fabric and said thin-cell-rechargeable-battery;
wherein said at least one suction-cup is detachably affixable to said rigid-backboard to provide a detachable coupling to a surface;
wherein said one or more photovoltaic-cells are structured and arranged to charge said thin-cell-rechargeable-battery via a light-source;
wherein said charging assembly is structured and arranged to provide an electrical power source to said luminous-fiber-optic-fabric;
wherein said luminous-fiber-optic-fabric is structured and arranged to cover and conceal said thin-cell-rechargeable-battery;
wherein said illuminated mobile sign system is structured and arranged to allow a user to display an illuminated image upon said surface via said sign assembly.
wherein said illuminated image includes alphanumeric text;
wherein said light-source is ultra-violet radiation from a solar-source;
wherein said thin-cell-rechargeable-battery is removable and replaceable;
wherein said charging assembly includes a charging-port such that said user can recharge said thin-cell-rechargeable-battery via an electrical-current-source;
wherein said at least one suction-cup is removable and reversible to provide said user with multiple mounting options;
wherein said rigid-backboard is constructed from a plastic material to provide durability and longevity and prevent damage to said surface during use;
wherein said luminous-fiber-optic-fabric includes an on-off switch;
wherein said illuminated mobile sign system is weather-resistant;
wherein said periphery exhibits a badge-shape to provide a more formal aesthetic design; and
wherein said surface is a window of a vehicle.

18. The illuminated mobile sign system of claim 17 further comprising a kit including:
said sign assembly;
said charging-assembly;
said at least one suction-cup; and
a set of user instructions.

19. A method of using an illuminated mobile sign system comprising the steps of:
providing an illuminated mobile sign system comprising a sign assembly, a charging assembly, and at least one suction-cup;
affixing said illuminated mobile sign system to a surface;
charging said illuminated mobile sign system via a light-source;
switching said illuminated mobile sign system into an on-mode; and
displaying an illuminated-message.

20. The method of claim 19 further comprising the steps of
switching said illuminated mobile sign system into an off-mode; and
removing said illuminated mobile sign system from said surface.
